(19) United States
(12) Patent Application Publication
(10) Pub. No.: US 2010/0142796 A1
(43) Pub. Date: Jun. 10, 2010

(54) Inspection method and apparatus for substrate

(76) Inventors: Jen-Ming Chang, Banciao City (TW); Mau-Hsiung Hsu, Jhongli City (TW); Yen-Hsin Tseng, Longtan Township (TW); Guo-Cheng Ho, Pingjhen City (TW); Hsuan Yang, Banciao City (TW); Chih-Chieh Yu, Bancaio City (TW); Jia-Lin Shen, Taipei City (TW); Jui-Yu Lin, Lujhu Township (TW)

Correspondence Address: HAVERSTOCK & OWENS LLP, 162 N WOLFE ROAD, SUNNYVALE, CA, 94086, US

(21) Appl. No.: 12/315,699

(22) Filed: Dec. 5, 2008

(51) Int. Cl. G06K 9/00

(52) U.S. Cl. 382/141

(57) ABSTRACT

An inspection method and apparatus for a substrate are provided. The inspection apparatus includes an optical unit generating a light illuminating the substrate to generate an image, a sensor array receiving the image having a light wave comprising a wave-band within a range between 700 nm to 1500 nm, and an image processing unit capturing the image.

### FIELD OF THE INVENTION

The present invention is related to an inspection method and apparatus for a substrate, and more particularly to an optical inspection method and apparatus for inspecting defects of a substrate.

### BACKGROUND OF THE INVENTION

Inspecting and analyzing defects of a substrate is very important in the producing process thereof. For example, there are lots of factors resulting in cracks of a solar panel, e.g. a defect of the original material and the conveyance during different processes could result in the cracks. Besides, the original material of the solar panel is silicon, which has joints apt to result in surface or internal fractures, and the fractures would have serious influences on the equipments of the producing process and on the efficiency of the solar panel.

Currently, there are two general ways of inspecting defects of a substrate. One is to detect current-voltage characteristics of the substrate, and the other is to visually detect the surface of the substrate with a high-intensity light. However, the mentioned ways have the following drawbacks. Firstly, the yield rate of the production process is reduced. The way of detecting current-voltage characteristics of the substrate is performed after the production process, and hence the substrates having defects can only be discarded or degraded. Therefore, there are no benefits to the yield rate of the production process, and the loss of the material and manpower during the production process will be generated. Furthermore, a minor crack could not be responded by the current-voltage detection but cause the products to crack easily during conveyance. Secondly, the inspection efficiency is poor. A visible light is used in the current high-intensity light detecting technique. The defects of the substrate may occur in the internal parts, most of which will not pass through the whole cross-section of the substrate. The high-intensity light is unable to be transmitted to the internal parts, and hence the way of visually estimating the surface of the substrate with a high-intensity light would result in large amounts of omission and the problem of poor inspection efficiency. Thirdly, the control of the quality is difficult. Since the current-voltage detection does not have enough sensitivity and is performed after the production process, and the high-intensity light detection would result in large amounts of omission, the quality of the products is difficult to be controlled. Potential dangerous factors would also be produced for the production machines. For example, if a solar panel having fractures cracks in a machine, efficiency thereof and the quality of subsequent products would be seriously influenced. Fourthly, calculation and analysis cannot be carried out during the process. In the prior art, there is no recording for the features of the defects and the classification therefor, and the relationship between the features of the defects and the production process is not effectively analyzed. That is to say, the inspection ways for a substrate in the prior art have no benefits to the improvement in the production process. Fifthly, the rate of breaking of the product is high. In the prior art, there is no supporting device well designed for the product during the inspection, and even the product is taken by hands for the inspection. Hence, the rate of breaking of the product is high, thereby increasing the production cost.

In order to overcome the mentioned drawbacks in the prior art, an inspection method and apparatus for a substrate are provided in the present invention.

### SUMMARY OF THE INVENTION

In accordance with one aspect of the present invention, an inspection method for a substrate is provided, which comprises illuminating the substrate with a light to generate an image; receiving the image, wherein a first light wave of the image comprises a wave-band within a range between 700 nm to 1500 nm; and analyzing the image to generate a defect inspecting result of the substrate. Hence, defects of the substrate can be precisely inspected.

The substrate is inspected in an optical inspection apparatus, which comprises an optical unit generating the light, a sensor array receiving the image having the first light wave, and an image processing unit capturing the image for analysis.

Preferably, the light comprises a wave-band within a range between 700 nm to 1500 nm, so that the image generated by the light has the first light wave comprising a wave-band within a range between 700 nm to 1500 nm.

Preferably, the mentioned inspection method further comprises a step of filtering out the light having a wavelength beyond a range of 700 nm to 1500 nm before the step of illuminating the substrate with the light. Alternatively, the mentioned inspection method further comprises a step of filtering out a second light wave of the image having a wavelength beyond a range of 700 nm to 1500 nm after the step of illuminating the substrate with the light.

Preferably, the mentioned inspection method further comprises steps of outputting the defect inspecting result and determining whether the substrate has a defect; analyzing a type and a degree of the defect; and producing a database of the defect based on the type and the degree of the defect. The step of analyzing the type comprises the analysis of a geometry information of the defect, and the analyzing the degree comprises the analysis of a rate of breaking and other related statistics.

In accordance with another aspect of the present invention, an inspection system for a substrate is provided, which comprises a carrier supporting and conveying the substrate, an optical inspection apparatus inspecting a defect of the substrate, and an analyzing system generating a defect inspecting result of the substrate. The optical inspection apparatus comprises an optical unit generating a light illuminating the substrate to generate an image and a sensor array receiving the image, wherein a light wave of the image comprises a wave-band within a range between 700 nm to 1500 nm.

Preferably, the inspection system further comprises a data collection unit collecting the defect inspecting result, and a calculating unit determining whether the substrate has a defect according to the defect inspecting-result, analyzing a type and a degree of the defect and producing a database of the defect based on the type and the degree of the defect.

Preferably, the carrier comprises a conveyer stage and a supporting stage. Furthermore, the carrier is one selected from a group consisting of an X-Y axes moving stage, a belt conveyor, a roller stage, an air floating stage, a transparent glass carrier, a conveyer without a top and a bottom plates, and a combination thereof.

In accordance with a further aspect of the present invention, an inspection apparatus for a substrate is provided, which comprises an optical unit generating a light illuminating the substrate to generate an image, a sensor array receiving the image having a light wave comprising a wave-band within a range between 700 nm to 1500 nm, and an image processing unit capturing the image.

Preferably, the sensor array is one selected from a group consisting of a CMOS, a CCD, an InGaAs Focal Plane, a spectrometer and a spectroscopic sensor module.

Preferably, the light generated by the optical unit comprises a wave-band within a range between 700 nm to 1500 nm.

Preferably, the optical inspection apparatus further comprises a filter for filtering out the light having a wavelength beyond a range of 700 nm to 1500 nm.

Preferably, the optical unit is disposed in a position being one selected from a group consisting of positions above the substrate, below the substrate and around the substrate, and the image is generated by a way being one selected from a group consisting of transmitting the light through the substrate, reflecting the light on the substrate, and a combination thereof.

Preferably, the substrate is selected from one of a solar panel and an element having a silicon material. Furthermore, the defect is one selected from a group consisting of a surface defect, an internal structure defect, and a combination thereof.

Based on the above, the present invention has the following advantages. Firstly, the carrier comprises a conveyer stage and a supporting stage, so that the break and crack of the substrate during the conveyance could be avoided, especially for the substrate with thin silicon material. Secondly, the optical inspection for the substrate uses a light having a specific wave-band within a range between 700 nm to 1500 nm, and hence defects of the substrate can be precisely inspected. Thirdly, a database of defects can be established based on the features thereof by an analyzing and calculating system, and the database would become an important asset for the industry.

The present invention may best be understood through the following descriptions with reference to the accompanying drawings, wherein:

### BRIEF DESCRIPTION OF THE DRAWINGS

FIG. 1(A) shows an inspection apparatus according to an embodiment of the present invention;

FIG. 1(B) shows an inspection apparatus according to another embodiment of the present invention;

FIG. 1(C) shows an inspection apparatus according to a further embodiment of the present invention; and

FIG. 2 shows an inspection system according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

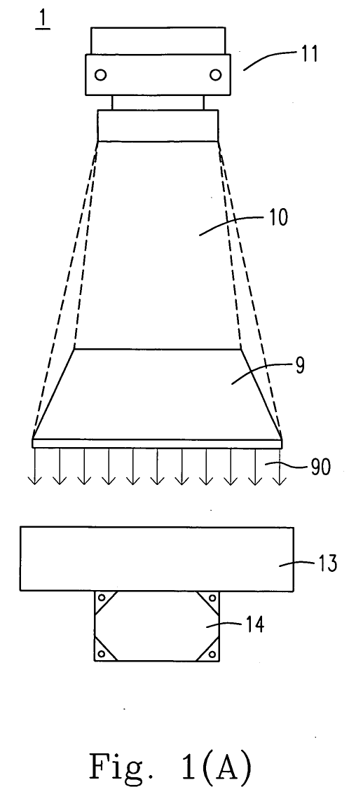

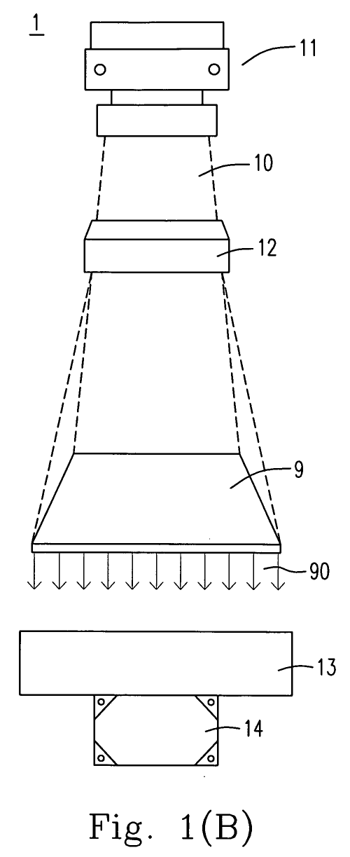

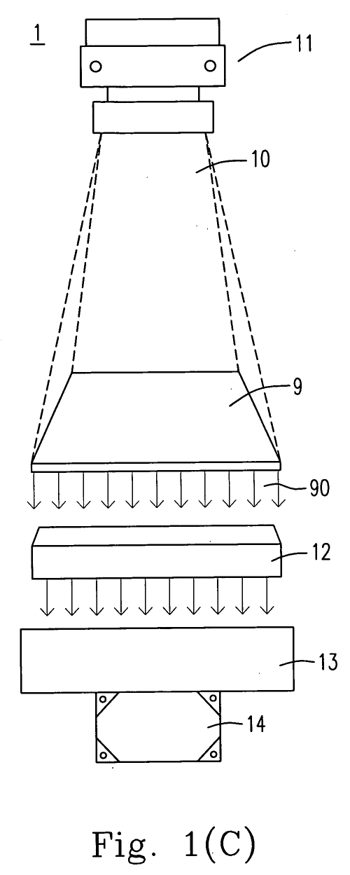

Please refer to FIG. 1(A), which shows an inspection apparatus according to an embodiment of the present invention. The inspection apparatus 1 comprises an optical unit 11, a sensor array 13 and an image processing unit 14. The optical unit 11 generates a light 10 for illuminating the substrate 9 to generate an image 90, wherein the light 10 comprises any one of a wave-band within a range between 700 nm to 1500 nm. Subsequently, the sensor array 13 receives the image 90 having a light wave comprising a wave-band within the range between 700 nm to 1500 nm, and the image processing unit 14 captures the image received from the sensor array 13 for an analysis of defects of the substrate 9.

Please refer to FIG. 1(B), which shows an inspection apparatus according to another embodiment of the present invention. The inspection apparatus 1 for a substrate 9 comprises an optical unit 11, a sensor array 13, an image processing unit 14, and a filter 12 disposed between the optical unit 11 and the substrate 9. In this embodiment, the wavelength of the light 10 generated by the optical unit 11 is in whole wave band, and the filter 12 filters out the light 10 having a wavelength beyond a range of 700 nm to 1500 nm before illuminating the substrate 9 with the light 10 to generate an image 90, so that the substrate 9 will be illuminated with the light 10 comprising a wave-band within a range between 700 nm to 1500 nm. Subsequently, the sensor array 13 receives the image 90 having a light wave comprising a wave-band within the range between 700 nm to 1500 nm, and the image processing unit 14 captures the image 90 received from the sensor array 13 for an analysis of defects of the substrate 9.

Please refer to FIG. 1(C), which shows an inspection apparatus according to a further embodiment of the present invention. The inspection apparatus 1 for a substrate 9 comprises an optical unit 11, a sensor array 13, an image processing unit 14, and a filter 12 disposed between the substrate 9 and the sensor array 13. In this embodiment, the wavelength of the light 10 illuminating the substrate 9 to generate an image 90 is in whole wave band, and the filter 12 filters out a light wave of the image 90 having a wavelength beyond a range of 700 nm to 1500 nm after illuminating the substrate 9 with the light 10. Subsequently, the sensor array 13 receives the image 90 having a light wave comprising a wave-band within the range between 700 nm to 1500 nm, and the image processing unit 14 captures the image 90 received from the sensor array 13 for an analysis of defects of the substrate 9.

Though the optical unit 11 is disposed in a position above the substrate 9 in the above embodiments, practically the position could be one selected from a group consisting of positions above the substrate, below the substrate and around the substrate. Furthermore, the image 90 is generated by a way being one selected from a group consisting of transmitting the light 10 through the substrate 9, reflecting the light 10 on the substrate 9, and a combination thereof.

According to the above embodiments, the sensor array 13 is one selected from a group consisting of a CMOS, a CCD, an InGaAs Focal Plane, a spectrometer and a spectroscopic sensor module. Furthermore, the image-processing unit 14 comprises one selected from a group consisting of a capturing unit, a processing unit, a display unit, a storing unit, and a combination thereof.

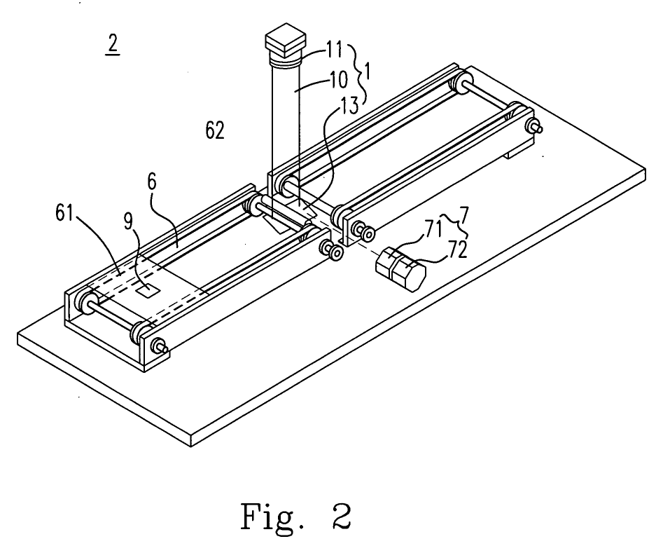

Please refer to FIG. 2, which shows an inspection system according to an embodiment of the present invention. The inspection system 2 for a substrate 9 comprises a carrier 6 supporting and conveying the substrate 9, an optical inspection apparatus 1 as shown in FIGS. 1(A)-1(C), and an analyzing system 7 analyzing the image 90 captured from the inspection apparatus 1 to generate a defect inspecting result of the substrate 9.

According to the above embodiment, the analyzing system 7 comprises a data collection unit 71 collecting the defect inspecting result, and a calculating unit 72 determining whether the substrate 9 has a defect according to the defect inspecting result, analyzing a type and a degree of the defect and producing a database of the defect based on the type and the degree of the defect.

According to the above embodiment, the carrier 6 comprises a supporting stage 61 and a conveyer stage 62. The carrier 6 could be one selected from a group consisting of an X-Y axes moving stage, a belt conveyor, a roller stage, an air floating stage, a transparent glass carrier, a conveyer without a top and a bottom plates, and a combination thereof.

An inspection method for a substrate according to the present invention is also provided in the above embodiments. The substrate 9 is conveyed to the inspection apparatus 1 by the carrier 6 and illuminated with the light 10 to generate the image 90 to be received by the sensor array 13, wherein the image 90 received by the sensor array 13 has a light wave comprising a wave-band within a range between 700 nm to 1500 nm. Subsequently, the image 90 received by the sensor array 13 is analyzed to generate a defect inspecting result of the substrate 9.

According to the above embodiments, the inspection method may further comprise the steps of outputting the defect inspecting result, determining whether the substrate 9 has a defect, analyzing a type and a degree of the defect, and producing a database of the defect based on the type and the degree of the defect. The step of analyzing the type comprises the analysis of a geometry information of the defect, and the analyzing the degree comprises the analysis of a rate of breaking and other related statistics.

According to the above embodiments, the substrate 9 is a solar panel, e.g. a single-crystalline silicon solar cell panel, a multi-crystalline silicon solar cell panel, or a thin-film solar cell panel. Besides, the substrate 9 may be other elements having a silicon material, such as thin-film optoelectronic devices and HIC (hybrid integrated circuit) devices. Furthermore, the defect of the substrate 9 could be one selected from a group consisting of a surface defect, an internal structure defect, and a combination thereof.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An inspection method for a substrate, comprising steps of:
illuminating the substrate with a light to generate an image;
receiving the image, wherein a first light wave of the image comprises a wave-band within a range between 700 nm to 1500 nm; and
analyzing the image to generate a defect inspecting result of the substrate.

2. The inspection method according to claim 1, wherein the substrate is selected from one of a solar panel and an element having a silicon material.

3. The inspection method according to claim 1, wherein the substrate is inspected in an optical inspection apparatus comprising:
an optical unit generating the light;
a sensor array receiving the image; and
an image processing unit capturing the image for analysis.

4. The inspection method according to claim 1, wherein the light comprises a wave-band within a range between 700 nm to 1500 nm.

5. The inspection method according to claim 1, further comprising a step being one of:
filtering out the light having a wavelength beyond a range of 700 nm to 1500 nm before the step of illuminating the substrate with the light; and
filtering out a second light wave of the image having a wavelength beyond a range of 700 nm to 1500 nm after the step of illuminating the substrate with the light.

6. The inspection method according to claim 1, wherein the defect inspecting result is one selected from a group consisting of a surface defect, an internal structure defect, and a combination thereof.

7. The inspection method according to claim 1, further comprising steps of:
outputting the defect inspecting result and determining whether the substrate has a defect;
analyzing a type and a degree of the defect; and
producing a database of the defect based on the type and the degree of the defect.

8. An inspection system for a substrate, comprising:
a carrier supporting and conveying the substrate;
an optical inspection apparatus, comprising:
an optical unit generating a light illuminating the substrate to generate an image; and
a sensor array receiving the image, wherein a light wave of the image comprises a wave-band within a range between 700 nm to 1500 nm; and
an analyzing system analyzing the image to generate a defect inspecting result of the substrate.

9. The inspection system according to claim 8, further comprising:
a data collection unit collecting the defect inspecting result; and
a calculating unit determining whether the substrate has a defect according to the defect inspecting result, analyzing a type and a degree of the defect and producing a database of the defect based on the type and the degree of the defect.

10. The inspection system according to claim 8, wherein the substrate is selected from one of a solar panel and an element having a silicon material.

11. The inspection system according to claim 8, wherein the light generated by the optical unit comprises a wave-band within a range between 700 nm to 1500 nm.

12. The inspection system according to claim 8, wherein the optical inspection apparatus further comprises a filter for filtering out the light having a wavelength beyond a range of 700 nm to 1500 nm.

13. The inspection system according to claim 8, wherein the optical unit is disposed in a position being one selected from a group consisting of positions above the substrate, below the substrate and around the substrate, and the image is generated by a way being one selected from a group consisting of transmitting the light through the substrate, reflecting the light on the substrate, and a combination thereof.

14. The inspection system according to claim 8, wherein the sensor array is one selected from a group consisting of a CMOS, a CCD, an InGaAs Focal Plane, a spectrometer and a spectroscopic sensor module.

15. The inspection system according to claim 8, wherein the carrier comprises a conveyer stage and a supporting stage.

16. The inspection system according to claim 8, wherein the carrier is one selected from a group consisting of an X-Y axes moving stage, a belt conveyor, a roller stage, an air floating stage, a transparent glass carrier, a conveyer without a top and a bottom plates, and a combination thereof.

17. An inspection apparatus for a substrate, comprising:
an optical unit generating a light illuminating the substrate to generate an image;
a sensor array receiving the image, wherein a light wave of the image comprises a wave-band within a range between 700 nm to 1500 nm; and
an image processing unit capturing the image.

18. The inspection apparatus according to claim 17, wherein the light generated by the optical unit comprises a wave-band within a range between 700 nm to 1500 nm.

19. The inspection apparatus according to claim 17, further comprising a filter for filtering out the light having a wavelength beyond a range of 700 nm to 1500 nm.

20. The inspection apparatus according to claim 17, wherein the optical unit is disposed in a position being one selected from a group consisting of positions above the substrate, below the substrate and around the substrate, and the image is generated by a way being one selected from a group consisting of transmitting the light through the substrate, reflecting the light on the substrate, and a combination thereof.
